(19) United States
(12) Patent Application Publication
(10) Pub. No.: US 2008/0087328 A1
(43) Pub. Date: Apr. 17, 2008

(54) Method and Plant for Transport of Rich Gas

(75) Inventors: Tor Christensen, Sandefjord (NO); Henrik Fleischer, Slependen (NO); Knut Borseth, Tarnasen (NO)

Correspondence Address: BIRCH STEWART KOLASCH & BIRCH, PO BOX 747, FALLS CHURCH, VA, 22040-0747, US

(73) Assignee: Sargas AS, P.O. Box 2451 Solli (NO)

(21) Appl. No.: 11/666,153

(22) PCT Filed: Oct. 25, 2005
(86) PCT No.: PCT/NO05/00405

§ 371 Date: Jul. 26, 2007

(30) Foreign Application Priority Data
Oct. 25, 2004 (NO) 20044585

(51) Int. Cl. F17D 1/00

(52) U.S. Cl. 137/13; 137/372

(57) ABSTRACT

A method for transport of natural gas through a pipeline from a gas field to a terminal, where there is a risk of condensation of heavy hydrocarbon components in the pipeline during the transport, wherein dry gas is added to the natural gas to reduce the cricondentherm and the cricondentherm of the gas and thus prevent condensation in the pipeline, is described. A plant for carrying out the method is also described.

### FIELD OF INVENTION

The present invention relates to offshore technology, more specifically to transport of gas in pipelines ashore from a gas field or transport between gas fields.

### TECHNICAL BACKGROUND

Offshore gas fields may be situated far away from the shore. Additionally, some of the large gas fields discovered the latest years are situated in remote ocean areas having a rough climate, like the Norwegian Sea and the Barents Sea. The long distance from the gas field combined with the rough climate and great ocean depths makes the traditional production platforms impractical and too expensive, and makes it more preferable to use sub-sea production facilities and sub-sea pipelines for transporting the gas ashore before treatment.

Untreated natural gas comprises a mixture of light and heavy components. The heavy components have a tendency to condense as a liquid as the temperature and pressure falls. Even if the temperature and pressure at the production end of a pipeline are sufficiently high to keep all the components in the natural gas in gas phase, both the temperature and pressure fall along the pipeline due to heat loss and friction. The condensation of liquid in the pipeline is unwanted as it results in multiphase flow in the pipeline. Multiphase flow is a very complicated phenomenon. The flow pattern is dependent on the relative portions of gas and liquid, the velocity of flow for each phase and terrain on which the pipeline is resting. Multiphase flow results in increased friction loss, accumulation of large amounts of liquid in the pipeline, potentially slug flow and increased risk for corrosion of the pipeline. The increased risk for corrosion makes it necessary to use high grade steel in the pipeline, thus increasing the cost.

The traditional way to avoid condensation, and thus multiphase flow, in pipelines for natural gas from offshore production facilities, has been to separate the gas in a heavy fraction, and a light fraction that are transported separately. The separation does, however, require process facilities not available in remote sub-sea production facilities.

It has been suggested to use “booster stations” to boost the pressure and the temperature of the gas to avoid condensation in the pipeline. The distance between the booster stations is dependent on the composition of the natural gas and the initial pressure of the gas. During the lifetime of a gas field, the natural gas may include an increasing amount of condensable gas, and the pressure of the gas will decrease. Accordingly, it may be necessary to have one booster station per 200 km pipeline, or even at shorter distance from each other. Booster stations increase the cost of the pipeline, and are additionally expected to require frequent maintenance, which may result in expensive production stops and problems during restart of the station.

U.S. Pat. No. 2,958,205 relates to a method of transporting a normally gaseous fluid over long distance in a pipeline system, where the fluid is liquefied by compression and cooling, and where one or more re-liquefying and pumping stations are arranged at predetermined intervals along the pipeline. Re-liquefaction and pumping stations are provided at preset intervals along the line to re-liquefy the portion of the gas that vaporized part of the fluid to keep the multiphase current at a controllable level. Liquefaction normally involves compression, possibly with cooling and expansion of the gas. This is a fairly complex process which consumes large amounts of energy. Typically, the energy must be produced locally, adding complexity and cost.

Accordingly, there still exists a need for an improved method and plant for transport of rich gas over a long distance where the shortcomings mentioned above are avoided.

### SUMMARY OF THE INVENTION

According to a first aspect, the present invention relates to a method for transport of natural gas through a pipeline from a gas field to a terminal, where there is a risk of condensation of heavy hydrocarbon components in the pipeline during the transport, wherein dry gas is added to the natural gas to reduce the cricondentherm and the cricondentherm of the gas and thus prevent condensation in the pipeline.

Preferably the dry gas additionally is used to increase the pressure of the gas in the pipeline. The increased pressure increases the difference between the pressure of the gas and the cricondenbar of the gas, resulting in reduced risk for condensation of hydrocarbons.

Addition of the dry gas serves to increase the velocity of the gas in the pipeline, in particular when the gas field has a reduced production rate such as in late field life or during periods with reduced gas demand. The major benefit of keeping a high velocity in the pipeline is that the gas will then sweep any liquids, such as water or water/glycol mixtures, out of the pipeline. Liquids therefore will not accumulate in the pipeline, but are removed efficiently on a continual basis regardless of the gas production rate. This reduces the need for pipeline scrapers.

According to an embodiment, the pressure of the gas is increased by injecting the dry gas at high pressure, parallel with the current in the pipeline.

According to an alternative embodiment, the pressure of the gas is increased by means of compressors propelled by expansion of the dry gas prior to injection into the pipeline.

According to one embodiment, dry gas is injected at predetermined injection points along the pipeline.

Depending on the original pressure and temperature of the natural gas, at least a part of the dry gas may be added to the natural gas close to the gas well.

According to a preferred embodiment, the gas in the pipeline is separated at the terminal in wet gas fraction and a dry gas fraction, where at least a portion of the dry gas is returned to the gas field to be added to the natural gas to prevent condensation of heavy components in the pipeline.

According to a second aspect, the present invention relates to a plant for transporting natural gas from a gas field to a terminal, the plant comprising a main pipeline for transporting the natural gas, wherein the plant additionally comprises injection points for addition of dry gas to the natural gas.

According to one embodiment, the plant additionally comprises a primary mixing unit close to the gas well for addition of at least a portion of the dry gas to the natural gas.

According to a preferred embodiment, the plant comprises a dry gas pipeline for transporting dry gas from the terminal to the gas field.

Preferably, the terminal comprises separation means for separation of the gas received at the terminal into a dry gas fraction of which at least a part is transported to the gas field for addition to the natural gas, and wet gas fraction.

According to an embodiment, the primary mixing unit and/or the injection points comprise injectors introducing the dry gas at high pressure parallel to the gas stream of natural gas in the pipeline to boost the pressure thereof.

### BRIEF DESCRIPTION OF THE FIGURES

FIG. 1 is a principle drawing of a plant for transport of rich gas according to the present invention,

FIG. 2 is a principle drawing of an onshore unit of the plant according to the present invention,

FIG. 3 is a principle drawing illustrating a longitudinal section through an embodiment of an injector,

FIG. 4 is a principle drawing illustrating a longitudinal section through an alternative embodiment of an injector, and

FIG. 5 is a principle drawing of a further embodiment of an injector.

### DETAILED DESCRIPTION OF THE INVENTION

The present invention is based on avoidance of condensation by reducing the mean molar weight of the transported gas. Condensation of a natural gas is dependent on the composition of the gas, or the mean molar weight of the gas, the pressure and the temperature. To avoid condensation of a gas, the temperature of the gas must be higher than the cricondentherm of the gas and/or the pressure of the gas must be higher than the cricondenbar of the gas. The cricondentherm is the maximum temperature at which two phases may exist, and the cricondenbar, is the maximum pressure at which two phases may exist,

In subsea pipelines, the temperature of the gas is rapidly reduced to the ambient temperature of about +4° C. Due to friction loss, the pressure will be reduced along the pipeline. When the pressure falls below the cricondenbar, condensation will occur.

The cricondentherm and cricondenbar of a natural gas are dependent on the composition, or the mean molar weight of the natural gas. The higher the mean molar weight is, the higher the cricondentherm and the cricondenbar are. The present invention is based on the fact that the mean molar weight is reduced by adding dry gas, or substantially pure methane, to a rich natural gas comprising methane in mixture with heavier hydrocarbons. By reducing the mean molar weight, both the cricondentherm and cricondenbar are reduced.

The term “dry gas” is in the present description and claims intended to mean a hydrocarbon gas mostly comprising methane. The dry gas normally comprises more 90% methane, preferably more than 95% methane.

A natural gas having a mean molar weight of 22.2 kg/kgmol, has a cricondentherm of +31° C. and a cricondentherm of 105.4 bara, whereas a natural gas having a mean molar weight of 16.4 has a cricondentherm of −20° C., and a cricondenbar below 70 bara. Condensation of natural gas in the pipeline is thus avoided by reducing the molar weight of the natural gas to give the gas a cricondentherm below the ambient temperature, and at the same time reduce the cricondenbar.

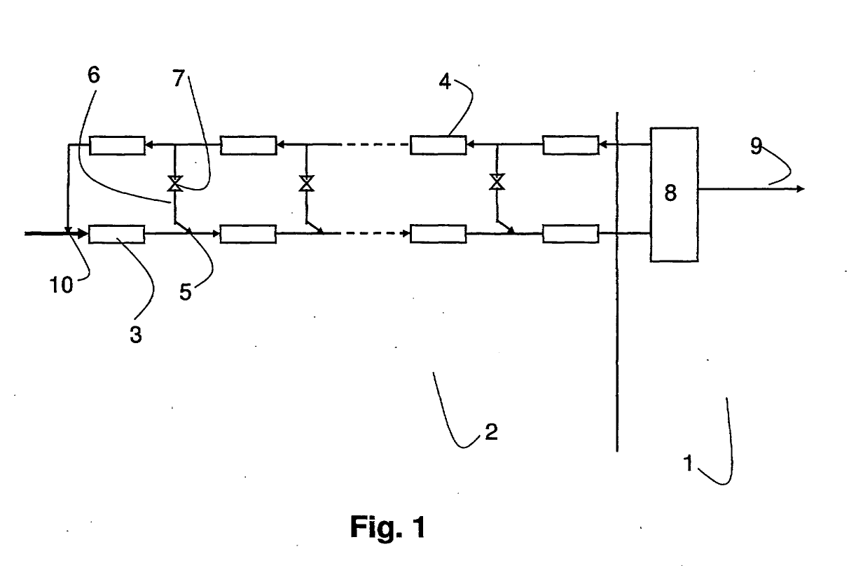

FIG. 1 is a principle drawing of a plant according to the present invention. The plant comprises two main parts, an onshore unit 1 and a subsea unit 2. The subsea 2 unit comprises two pipelines, a main pipeline 3 for transporting natural gas from the gas wells to the onshore unit, and a dry gas pipeline 4, for transporting dry gas, mainly comprising methane, under high pressure from the onshore unit towards the gas wells. The dry gas is transported to the gas wells, where the dry gas is mixed with the natural gas in one or more primary mixing unit(s) (10). Additionally, glycol (mono ethylene glycol (MEG)) that is used to prevent water to form ice and/or hydrates in the pipeline. The mixture of natural gas and dry gas is transported from the primary mixing unit(s) 10 in the main pipeline 3 towards the onshore unit 1.

In relative short pipelines all the dry gas is added to the natural gas in the primary mixing unit(s) close to the gas wells. For longer pipelines, the pressure will drop along the pipeline. For longer pipelines, it is therefore preferred to add a part of the total dry gas to be added in the primary mixing unit(s) 10 and add additional dry gas at predetermined injection points 5 along the main pipeline 3. The dry gas to be added at the injection points 5 is taken out from the dry gas line 4 and led to the main pipeline 3 in injector pipes 6. The pressure and amount of dry gas in each of the injection pipes are controlled by means of control valve(s) 7. The effect of inserting gas along the pipeline, will be both to boost the pressure in the gas to be transported, and to reduce the mean molar weight of the gas as the pressure and temperature drops.

In the present description and claims the term “near ” and “close to” the oil well, with regard to the primary mixing or injection point for dry gas into the natural gas, is intended to mean that the primary mixing or injection point is in a production unit, such as a subsea production unit. Such a unit is normally connected to a plurality of oil wells within a distance a few km, such as e.g. 10 km or less.

The optimal location of each injection point along the pipeline and the pressure and amount of gas to be injected, to give the optimal transport of natural gas, without the risk of condensation and accompanying multiphase current in the pipeline, may be theoretically calculated.

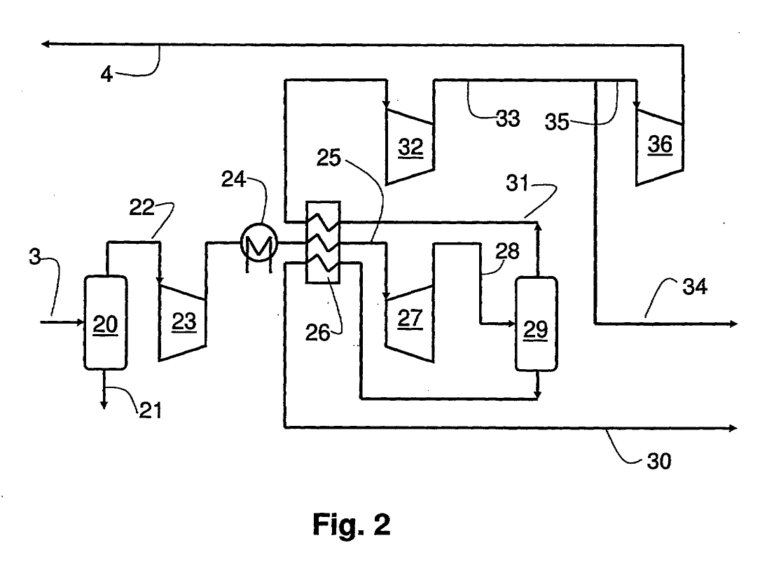

FIG. 2 illustrates an exemplary onshore part 1 of the plant. The gas from the field, comprising a mixture of natural gas and added dry gas, enters the onshore part through the main pipeline 3 and is led into a primary separator 20. In the primary separator, any water and glycol are separated from the gas and are removed through outlet 21. The gas is taken out from the primary separator 20 through a line 22 to a compressor 23, where the gas is compressed to a pressure of e.g., 100 to 200 bara. The compressed gas is then cooled in a water cooler 24. The temperature of the gas leaving the water cooler 24 may vary depending on the temperature of the available cooling water. In tropical waters the temperature of the gas leaving the cooler is typically about 45° C., in the North Sea the temperature may be about 30°C., whereas it is possible to cool the gas to a temperature of about 20° C. in colder climate zones. The water cooler 24 may alternatively be substituted by an air cooler. If the gas in the main pipeline has a pressure higher than about 100 bara, the compressor 23 may be omitted.

The gas from the cooler 23 is then led through a line 25 to a heat exchanger 26, where the gas is cooled against cool gas and liquid to a temperature typically from about −25° C. to about −75° C., e.g. about −50° C., before the gas is expanded in an expander 27 to a pressure typically from about 30 to 60 bara, e.g. about 40 bara. The temperature of the expanded gas will then be about −64° C., causing some of the ethane and most of the heavy components (C₃₊) to liquefy, whereas the dry gas, typically comprising 90 to 95% methane, some ethane in addition to minor amounts of propane and heavier components, remains in gas phase. The gas/liquid mixture is removed from the expander through a line 28 to a cold separator 29 wherein the liquid is collected at the bottom and is removed through a liquid line 30 via the heat exchanger 26 where it is heated to a temperature a few degrees below the temperature of the incoming gas from the cooler, e.g. to a temperature of about −4° C. The temperature of the heated gas may however vary and is dependent on the characteristics of the heat exchanger. The liquid in the liquid line is then stabilized by removal of dissolved methane, and is removed from the plant for export.

The uncondensed gas in the cold separator is removed through a gas outlet 31, is heated in the hat exchanger 26 and is compressed by means of a compressor 32. The compressed gas from the compressor 32 is led in a line 33 that is split into a gas export line 34 for gas to be exported from the plant, and a return line 35. The gas in the return line 35 is compressed in a compressor 36 and is returned to the gas wells and to the injection points along the gas pipeline, in the dry gas pipeline 4.

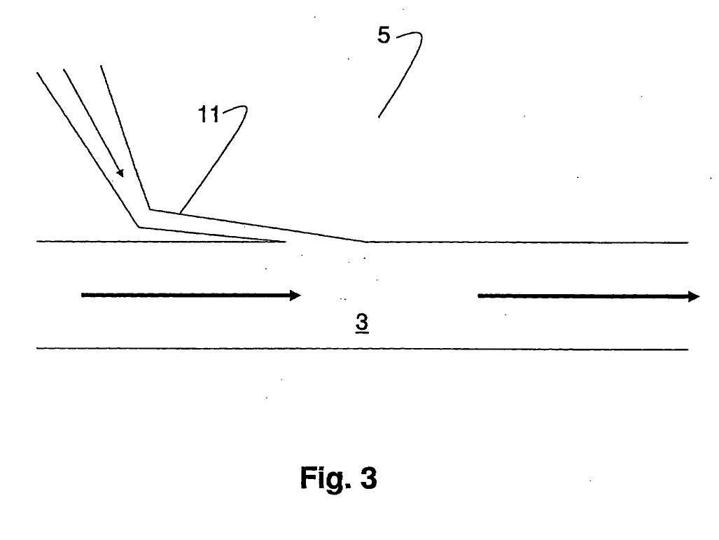

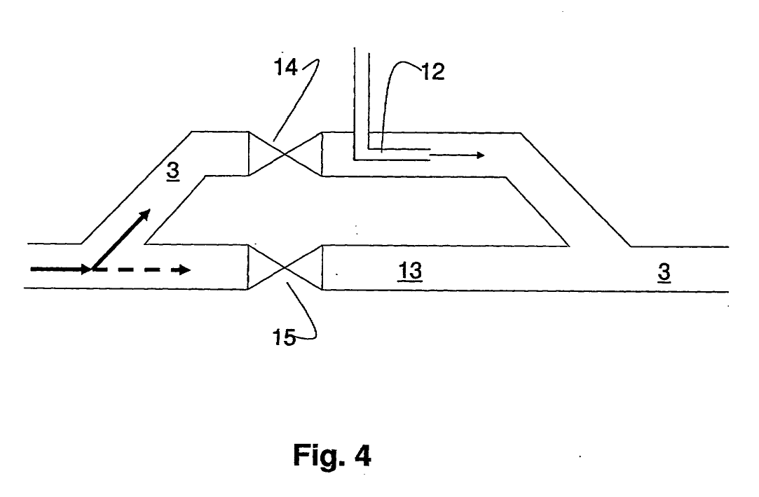

FIGS. 3, 4 and 5 illustrate three different embodiments of the injection points 5. The embodiments according to FIGS. 3 and 4 are based on the utilization of the ejector effect to increase the velocity of the gas in the main pipeline 3. The light, dry gas is introduced into the pipeline by means of injectors where dry gas having a high pressure is injected substantially parallel with the gas flow of the gas in the pipeline 4. The injector here functions as an ejector dragging the gas at the downstream side towards the onshore part.

FIG. 3 is a longitudinal section through the main pipeline at an injection point 5, where the dry gas is introduced through an injection tube 11 entering the main pipeline at an acute angle. The opening of injection tube in this embodiment does not project into the main pipeline but ends flush with the inner wall of the pipeline. This construction allows a pig or scraper, used to clean the pipeline and remove condensed water, to pass the injection point without any conflict with the injection tube.

FIG. 4 is an alternative embodiment, being more effective than the embodiment according to FIG. 3. An injection tube 12 is inserted into the centre of the pipeline and ejects the dry gas substantially parallel with the gas current in the pipeline. The injection tube 12 of this embodiment is, however, more vulnerable than the injection tube according to FIG. 3, as it protrudes into the pipeline. To be able to send a pig or scraper through the pipeline, a bypass line 13, has to be provided at the injection point. When a pig is to pass the injection point, a valve 14 at the pipeline is closed at the same time as a valve 15 at the bypass line 13 is opened. After the pig has passed through the bypass 13, valve 15 is closed and valve 14 is opened.

The embodiment according to FIG. 3 is as mentioned above less effective than the embodiment according to FIG. 4, as the efficiency of the propulsive force is lower as the dry gas is injected from the wall of the pipeline and at an angle to the gas current in the pipeline. The construction according to FIG. 3 is, however, far simpler as it has no moving parts. The valves 14, 15 and the control system for opening and closing of the valves make the system more complex and may require control and inspection of the injection points.

Alternative embodiments of the injection points are also possible. The injection tube 11 may be modified to project into the pipeline so that it may be withdrawn into the wall of the pipeline or be pressed into the wall of the pipeline by the pig. During normal operation the jet stream leaving the injection tube may then be inserted in the middle of the pipeline and substantially parallel to the current of the gas to optimize efficiency of the injection, i.e. optimize the ejector effect. This is possible to obtain if the injection tube enters the pipeline at an acute angle in a longitudinally extended recess in the wall of the pipeline, the injection tube being extended having its “loose” end downstream in the pipeline. Under normal operation the dry gas will then be injected substantially parallel to the gas flowing in the pipeline. A pig following the gas stream from the well end of the pipeline will then push the injection tube into the recess of the wall of the pipeline. After the pig has passed the injection point, the injection tube will again resume its position. To make this possible the injection tube has to be made of a flexible material or the injection tube has to be hinged.

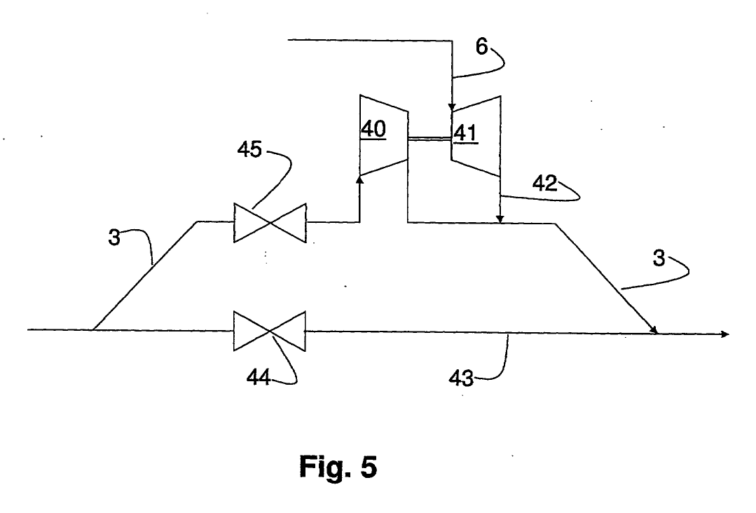

FIG. 5 illustrates an additional embodiment of an injection point according to the present invention. According to this embodiment, the injection point 5 includes a compressor 40 to increase the pressure of the gas to be transported. During normal operation, the gas flows through the main pipeline 3 and through the compressor 40. The energy to compress the gas in the compressor 40, is obtained by expanding the dry gas from injector pipes 6 over an expander 41. The expanded gas leaving the expander is introduced into the main pipeline 3 through a line 42. To be able to send a pig through the pipeline, a bypass line 43 is provided. A valve 44, which is closed during normal operation, is temporarily opened to let the pig pass through the bypass line. At the same time as the valve 44 is opened, a valve 45 on the main pipeline is closed. When the pig has passed the injection point, the valve 44 is closed and the valve 45 is opened again. This embodiment has the advantage that an effective and reliable pressure rise of the gas in the main pipeline is obtained. The disadvantages are that a bypass line is necessary and the additional inspection service needed for the compressor and expander.

Injection of dry gas into the natural gas provides at least four different effects that all increases the possibility to produce rich gas from remote and hostile offshore locations, such as a) mixture of gasses, b) boosting of the pressure/improved gas flow, c) independency of a tender vessel for effecting regular pigging of the pipeline, d) increased system control, and e) maintaining a high gas velocity to sweep any liquids such as glycol/water out of the pipeline on a continuous basis
a) Mixture of the Gasses

The heavy or rich gas is mixed with a light, or dry gas. The mean molar weight of the resulting gas will, dependent on the natural gas to dry gas ratio, be substantially reduced, resulting in a lower probability of condensation of the heavy components.

### EXAMPLE

A natural gas having a mean molar weight of 22.2 kg/kgmol, a cricondentherm of 31° C. and a cricondenbar of 105.4 bara, is mixed with a dry gas having a mean molar weight of 16.8 kg 7 kgmol, a cricondentherm of −65.1° C. and a cricondenbar of 55.3 bara. The table below gives the cricondenbar and cricondentherm for the resulting mixture.

| Natural gas to dry gas ratio | Cricondentherm | Cricondenbar |
|---|---|---|
| 1:1.8 | −1.7° C. | 88.9 bara |
| 1:2.5 | −7.5° C. | 86.8 bara |

For both the ratios exemplified in the table, the cricondentherm is reduced from 31° C. to below 0° C., so that condensation of hydrocarbon liquid and the resulting multiphase current, is substantially avoided. The cricondenbar is reduced from 105.4 bara to below 90 bara, giving additional protection against condensation. It is possible to increase the amount of dry gas in the total gas mixture to give even better protection against condensation. An increased share of dry gas in the total gas, will however, reduce the capacity of the main pipeline for transporting natural gas.
b) Boosting the Pressure/Improved Gasflow

The gas in the dry gas pipe is added to the main pipeline via ejectors or expander/compressor systems, to use the pressure energy of the dry gas to boost the pressure and enhance the flow of the resulting gas mixture.

In an exemplary long 36″ pipeline having a length of 600 km, a pressure of the natural gas of 180 bara and a pressure of the dry gas of 300 bara both at the well end of the pipeline, the natural gas and dry gas are mixed in a 1:2.5 ratio. Even if the efficiency of the ejector or expander/compressor system is low, e.g 35%, the pressure in the main pipeline will be increased by about 45 bar. This boosting of the pressure will increase the capacity of the pipeline and remove the pressure additionally from the cricondenbar to avoid condensation in the pipeline.
c) Independency of a Tender Vessel for Effecting Regular Pigging of the Pipeline

The reduction of cricondenbar and cricondentherm and the boosting of the pressure make it unlikely that hydrocarbon condensate is formed in the pipeline. A minor amount of water may, however, condense in the pipeline, together with glycol that is added to minimize the risk of hydrate formation.

The condensed water, and any glycol associated with the water, are removed from the pipeline by means of a “pig” that is introduced into the pipeline at the start end and is propelled by the pressure difference in the pipeline. Any liquid is pushed in a controlled way by the pig and is removed from the pipeline at the landfall end of the pipeline. The pig is traditionally returned to the well end by means of a surface vessel and inserted again. According to the present the return of the pig by means of a surface vessel is omitted as the pig may be returned to the well end of the pipeline in the dry gas pipeline. This makes a regular and frequent pigging independent of a “sub sea pig launcher” auxiliary vessel, possible.
d) System Control

The dry gas pipeline and the possibility of addition of adding dry gas to the natural gas makes an improved control of the system possible even though the pressure drops and the composition of the natural gas changes over the life time of the gas field.

To avoid condensation of hydrocarbons in the pipeline, it is preferred that the pressure in the pipeline is at least 20 bara higher than the cricondenbar of the gas. The amount of dry gas injected into the natural gas, and the location of the injection points may be adjusted to allow maximum capacity for transport of natural gas, at the same time as the pressure in the pipeline is kept at least 20 bara higher than the cricondenbar.

An exemplary natural gas having a mean molar weight of 22.2 kg/kgmol, giving a cricondentherm of 31° C. and a cricondentherm of 105.4 bara, is introduced into a 600 km 36″ pipeline at an initial pressure of about 182 bara, and a rate of about 1.500.000 Sm³/h. On arrival to the terminal the pressure is about 125 bara, giving a margin of about 20 bara above the cricondenbar.

At a flow rate of 500.000 Sm3/h, the pressure at the well would have to be 135 bara in order for the gas to arrive at the terminal with a pressure of 125 bara. If instead the well pressure drops to 125 bara at a rate of 500.000 Sm³/h, it is not possible to produce at this rate. The rate has to be further reduced to increase the well pressure to give a pressure at arrival at the terminal of at least 125 bara. Addition of about 1.000.000 Sm³/h dry gas at a pressure of 300 bara, where 50% is added 200 km from the terminal, 25% is added at an injection point 400 km from the terminal, and the remaining 25% close to the wells 600 km from the terminal, to the well stream of 500.000 Sm³/h at a initial pressure of 125 bara, will give a pressure at the arrival at the terminal of about 125 bara. The addition of dry gas has reduced the cricondenbar to 86 bara, resulting in a margin of more than 20 bara. The production rate will then be upheld at 500.000 Sm³/h without condensation of hydrocarbons in the pipeline.
e) Maintaining High Gas Velocities to Sweep Liquids out of the Pipeline

It is well known from shorter multiphase pipelines that liquids do not accumulate when the gas velocities are high. Lower velocities may however cause accumulation of liquids. When the velocities are again increased, severe slugging occur and very large amounts of liquids flow to the pipeline receiving end. This requires very large slug catchers. High gas velocities on a continuous basis are very desirable. The invention permits such high velocities during periods of low gas production and as the gas field ages with reduced production rates and reduced wellhead pressures.

The advantages obtained by the present invention are more pronounced as the pressure in the well decreases and/or the mean molar weight of the natural gas increases, than in the initial phase of the production. The total amount of dry gas and the proportions injected close to the wells and at the injection points may be adjusted as required during the total lifetime of the gas well to maximize the control and the production without the need for complicated booster stations.

The dry gas pipeline may additionally be used for transport glycol that is used for prevention or reduction of condensation of water and hydrate formation in the main pipeline 3.

1. Method for transport of natural gas through a pipeline from a gas field to a terminal, where there is a risk of condensation of heavy hydrocarbon components in the pipeline during the transport, wherein dry gas is added to the natural gas to reduce the cricondentherm and the cricondenbar of the gas and thus prevent condensation in the pipeline.

2. The method of claim 1, wherein the dry gas additionally is used to increase the pressure of the gas in the pipeline.

3. The method according to claim 2, wherein the pressure of the gas is increased by injecting the dry gas at high pressure, parallel with the current in the pipeline.

4. The method according to claim 2, wherein the pressure of the gas is increased by means of compressors propelled by expansion of the dry gas prior to injection into the pipeline.

5. The method according to claim 1, wherein dry gas is injected at predetermined injection points along the pipeline.

6. The method according to claim 1, wherein at least a part of the dry gas is added to the natural gas close to the gas well.

7. The method according claim 1, wherein the gas in the pipeline is separated at the terminal in wet gas fraction and a dry gas fraction, where at least a portion of the dry gas is returned to the gas field to be added to the natural gas to prevent condensation of heavy components in the pipeline.

8. A plant for transporting natural gas from a gas field to a terminal, the plant comprising a main pipeline (3) for transporting the natural gas, wherein the plant additionally comprises injection points (5) for addition of dry gas to the natural gas.

9. The plant according to claim 8, wherein the plant additionally comprises a primary mixing unit (10) close to the gas well for addition of at least a portion of the dry gas to the natural gas.

10. The plant according to claim 8, wherein the plant comprises a dry gas pipeline (4) for transporting dry gas from the terminal to the gas field.

11. The plant according to claim 8, wherein the terminal comprises separation means for separation of the gas received at the terminal into a dry gas fraction of which at least a part is transported to the gas field for addition to the natural gas, and wet gas fraction.

12. The plant according to claim 11, wherein the primary mixing unit (10) and/or the injection points (5) comprises injectors introducing the dry gas at high pressure parallel to the gas stream of natural gas in the pipeline to boost the pressure thereof.

13. The method according to claim 2, wherein dry gas is injected at predetermined injection points along the pipeline.

14. The method according to claim 3, wherein dry gas is injected at predetermined injection points along the pipeline.

15. The method according to claim 4, wherein dry gas is injected at predetermined injection points along the pipeline.

16. The method according to claim 2, wherein at least a part of the dry gas is added to the natural gas close to the gas well.

17. The method according to claim 3, wherein at least a part of the dry gas is added to the natural gas close to the gas well.

18. The method according to claim 4, wherein at least a part of the dry gas is added to the natural gas close to the gas well.

19. The method according to claim 5, wherein at least a part of the dry gas is added to the natural gas close to the gas well.

20. The method according to claim 2, wherein the gas in the pipeline is separated at the terminal in the wet gas fraction and a dry gas fraction, where at least a portion of the dry gas is returned to the gas field to be added to the natural gas to prevent condensation of heavy components in the pipeline.
